(19) United States
(12) Patent Application Publication
(10) Pub. No.: US 2013/0001944 A1
(43) Pub. Date: Jan. 3, 2013

(54) STARTING METHOD/APPARATUS FOR SERIES ELECTRIC DRIVE

(76) Inventors: Christopher D. Hickam, Peoria, IL (US); Baojun Si, Dunlap, IL (US)

(21) Appl. No.: 13/173,817

(22) Filed: Jun. 30, 2011

(51) Int. Cl. F02N 11/08; B60K 6/46

(52) U.S. Cl. 290/31; 180/65.245

(57) ABSTRACT

An improved system and method for starting an engine of an electric drive machine is disclosed. The method includes supplying electric current from a first energy storage device to inductive windings of a propulsion motor. The method also includes accumulating energy in the inductive windings of the propulsion motor based on a magnetic field created when the supplied electric current flows through the inductive windings. Electrical energy is generated by regulating a first plurality of switches associated with a first inverter to cause a collapse of the accumulated energy in the inductive windings. Such electrical energy is stored in an energy storage device. A controller regulates a second plurality of switches associated with a second inverter to cause a release of the stored electrical energy. The released electrical energy is supplied to a generator to start the engine.

### TECHNICAL FIELD

The present disclosure relates generally to a system and method for starting a machine having a series electric drive powertrain, and more particularly, to a system and method for starting an engine without a cranking motor.

### BACKGROUND

Electric drive machines generally include an engine and a generator configured to provide electric power to an electric motor for driving the machine. On large work machines, such as dozers, tractors, and trucks, the electric motors are large and powerful, and the engines are required to provide a substantial amount of power to drive the electric motors. Because of this, the engines are also large and powerful. Starting these engines requires high levels of power.

One typical starting system for these engines includes a starter and a battery. The starter for these engines must be large and robust to turn the engine until it is operating. These starters may be expensive and may eventually encounter mechanical problems requiring maintenance and expense to keep them operating.

Because the energy required to start these large engines is often higher than the energy offered in a standard battery, some starting systems include a separate power booster to boost the battery power to a level sufficient to start the engine. These power boosters are usually expensive and can require significant amount of maintenance.

Such conventional techniques of starting engines using large starters or cranking motors have been expensive and susceptible to mechanical problems. It is therefore desirable to provide, among other things, an improved engine starting arrangement.

### SUMMARY

In accordance with one embodiment, the present disclosure is directed to a system for starting an engine. The electric drive machine includes a first energy storage device, a plurality of inductive windings of a propulsion motor, a controller, a first plurality of switches associated with a first inverter, a second energy storage device, a second plurality of switches associated with a second inverter, a generator, an engine, and a gear train having a ground engaging system. The first energy storage device may be used to supply electric current to the plurality of inductive windings of a propulsion motor. The controller is configured to regulate the first plurality of switches associated with first inverter to cause a collapse of the accumulated energy in the inductive windings and discharge the inductive windings of electrical energy. The controller can also direct the electrical energy to be stored in the second energy storage device. The controller may also regulate the second plurality of switches to cause a release of the stored electrical energy. The generator, electrically coupled to the second plurality of switches associated with the second inverter, can receive such released electrical energy to start the engine.

In another embodiment, the present disclosure is directed to a method for starting an engine of an electric drive machine. The method includes supplying electric current from a first energy storage device to inductive windings of a propulsion motor. The method also includes accumulating energy in the inductive windings of the propulsion motor based on a magnetic field created when the supplied electric current flows through the inductive windings. Electrical energy is generated by regulating a first plurality of switches associated with a first inverter to cause a collapse of the accumulated energy in the inductive windings. Such electrical energy is stored in a second energy storage device. A controller regulates a second plurality of switches of a second inverter to cause a release of the stored electrical energy. The released electrical energy is supplied to a generator to start the engine.

### BRIEF DESCRIPTION OF THE DRAWINGS

FIG. 1 illustrates a schematic diagram of components of an electric drive machine in accordance with one embodiment.

FIG. 2 illustrates in flow-chart form a method of starting an engine of an electric drive machine in accordance with one embodiment.

### DETAILED DESCRIPTION

Reference will now be made in detail to exemplary embodiments, which are illustrated in the accompanying drawings. Wherever possible, the same reference numbers will be used throughout the drawings to refer to the same or like parts.

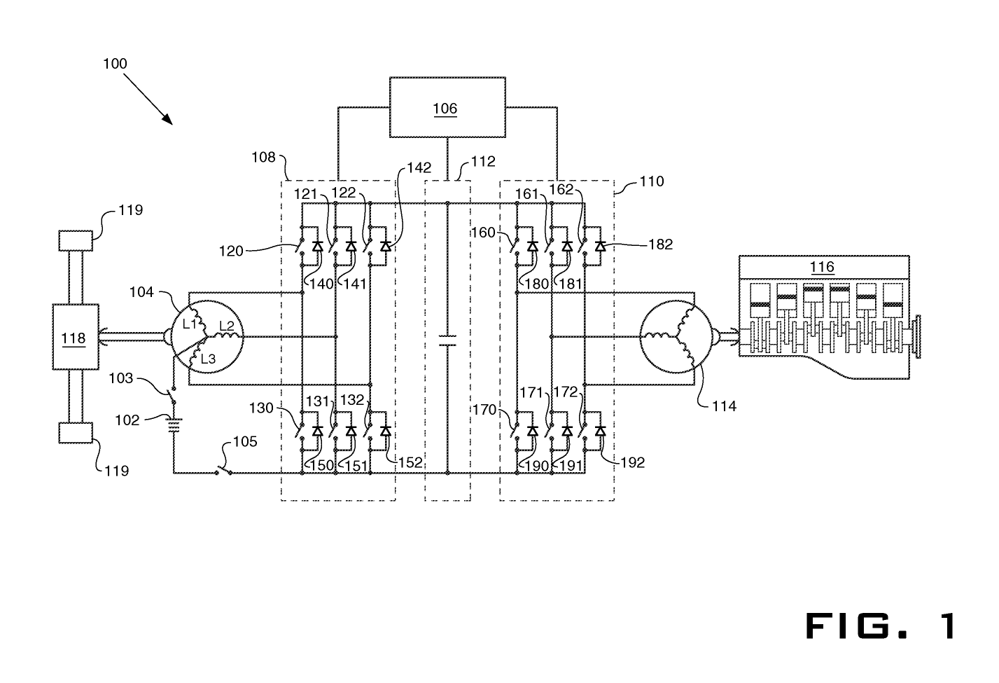

FIG. 1 illustrates a schematic diagram of an electric drive machine in accordance with one embodiment. The electric drive machine 100 may include a first energy storage device 102, a plurality of inductive windings L₁, L₂ and L₃ of a propulsion motor 104, a controller 106, a first inverter 108, a second energy storage device 112 (e.g., a capacitor), a second inverter 110, a generator 114, an engine 116 and gear train 118 having a ground engaging system 119.

The first energy storage device 102 may be used to supply electric current to the plurality of inductive windings L₁, L₂ and L₃ of a propulsion motor 104. The first energy storage device 102 can be a battery of any suitable type. First energy storage device 102 may be configured to provide power to engine 116 when the engine 116 is not running. The first energy storage device 102 may also power other systems and accessories on the electric drive machine 100.

The plurality of inductive windings 104 may be electrically coupled to the first energy storage device 102. The plurality of inductive windings L₁, L₂ and L₃ of the propulsion motor 104 can accumulate energy based on a magnetic field created when the supplied electric current flows through the inductive windings L₁, L₂ and L₃. The inductive windings L₁, L₂ and L₃ can be arranged such that a neutral node of the inductive windings connections is coupled to the first energy storage device 102. Each of the inductive windings L₁, L₂ and L₃ can be connected to a first plurality of switches of the first inverter 108. In some embodiments, the first plurality of switches may be associated with multiple inverters.

The controller 106 may control the operations of the first plurality of switches of the first inverter 108, the second energy storage device 112, and the second plurality of switches of the second inverter 110. The controller 106 may be configured to regulate the first plurality of switches of the first inverter 108 to cause a collapse of the accumulated energy in the inductive windings L₁, L₂ and L₃ of the propulsion motor 104 to thereby release/discharge electrical energy. That is, the controller may be configured to regulate the first plurality of switches associated with the first inverter 108 to cause a collapse of the magnetic field in the inductive windings of the propulsion motor, thereby producing an electro-motive force (EMF) proportional to the time rate of change of the magnetic flux. The controller 106 can also direct the electrical energy to be stored in the second energy storage device 112. The controller 106 may also regulate the second plurality of switches of the second inverter 110 to cause a release of the stored electrical energy. In some embodiments, the second plurality of switches may be associated with multiple inverters. The generator 114, which may be electrically coupled to the second plurality of switches of the second inverter 110, can receive such released electrical energy. Such electrical energy can be at a potential that is at least in part required to start the engine 116 of the electric drive machine 100.

In one example, the released electrical energy can be characterized by a voltage amplitude value that is sufficient to start the engine. As one example, the electric drive machine 100 may operate to boost the amplitude of a 24-volt first energy storage device to a maximum amplitude value of 650 volts so that the generator 114 can use the 650 volts as a motor to crank the engine 116. The second energy storage device 112 can be configured as any combination of a DC link capacitor, a motor link capacitor, and/or a generator link capacitor. Thus, the second energy storage device 112 can include one or more capacitors being associated with the first plurality of switches of the first inverter 108 and the second plurality of switches of the second inverter 110. In such embodiments, each of these capacitors may be arranged in parallel with sets of two switching elements. Although the second energy storage device 112 is described as capacitors, the energy storage device can be any other component capable of storing energy. Further, the second energy storage device 112 can be configured to be part of the first inverter 108 (motor converter), and/or as part of the second inverter 110 (generator converter).

In another example, the plurality of inductive windings L₁, L₂ and L₃ of the propulsion motor 104 are connected to the first energy storage device via a neutral node common to each of the inductive windings. In another example, the first inverter 108 and the second inverter 110 can be regulated by independently switching, respectively, each of the first plurality of switches through interleaved control operations. This helps reduce current ripple, especially in situations where three-phase interleaved control operations are applied to independently switch the plurality of switches associated with the first inverter 108. As used herein, current ripple refers to a small variation of a direct current output of a power supply. Such ripple is the direct voltage or current output of a power supply that varies but does not alternate.

Further, the controller 106 may be configured to send signals to the first inverter 108 and the second inverter 110. Based upon the signals, the switching elements 120-122 and 130-132 associated with the first inverter may be opened and/or closed to provide power/energy/charge accumulated in the inductive windings L₁, L₂ and L₃ of the propulsion motor 104 to the second energy storage device 112. The controller 106 may also be associated with the second energy storage device 112, and may be configured to monitor the power/energy/charge, such as voltage or current, passing through or stored in the second energy storage device 112. The controller 106 may also be configured to send signals to the second inverter 110 to open and close switching elements 160-162 and 170-172 so as to release the power/energy/charge accumulated in the second energy storage device 112 to the generator 114. Such released power/energy/charge may provide sufficient electrical energy to enable the generator 114 to start the engine 116 of the electric drive machine 100.

The controller 106 may include a computer having all of the components necessary to run an application, such as, for example, a memory serving as a storage device and a processor serving as a central processing unit. One skilled in the art will appreciate that this computer can contain additional or different components. Further, one skilled in the art will appreciate that operating conditions and/or operating sequences can be stored on or read from other types of computer programs, products, or computer readable media, such as computer chips and secondary storage devices, including hard disks, floppy disks, CD-ROMs or other forms of RAM or ROM

The engine 116 can be any engine known in the art, and including an internal combustion engine operating on diesel, gasoline, natural gas, propane, biofuels or other fuels. In one example, the engine 116 is a diesel-powered engine configured to power the electric drive machine 100.

The generator 114 may be coupled to a crankshaft on the engine 116 in a manner that the engine 116 drives the generator 114 to create power. When the engine 116 is not running, the generator 114 may be configured to crank the engine crankshaft to start the engine 114. The generator 114 may be sized and selected to provide sufficient power to drive the electric drive machine 100, and also to turn the crankshaft to start the engine 104. The second inverter 110 may be electrically associated with the generator 114 and may be configured to receive energy from the generator 114 and to convert the energy into usable power to operate the electric drive machine 100.

The gear train 118 may be coupled to and configured to drive the ground engaging system 119. The ground engaging system 119 may be any system configured to move the electric drive machine 100, and may include wheels or a track system, including gears or sprockets that may be capable of turning the wheels or track.

The propulsion motor 104 may include inductive windings L₁, L₂ and L₃ that serve as inductors. In one exemplary embodiment, the inductive windings L₁, L₂ and L₃ are stator windings in the propulsion motor 104. The stator windings may be configured to drive a rotor (not shown) to power the gear train 118, thereby driving the electric drive machine 100. Circuitry may electrically connect each of the inductive winding L₁, L₂ and L₃ between the switching elements that make up the pairs of switching elements in the first inverter 108 discussed above. As one example, the inductive winding L₂ is electrically connected between the pair of switching elements 121 and 131 associated with the first inverter 108.

### INDUSTRIAL APPLICABILITY

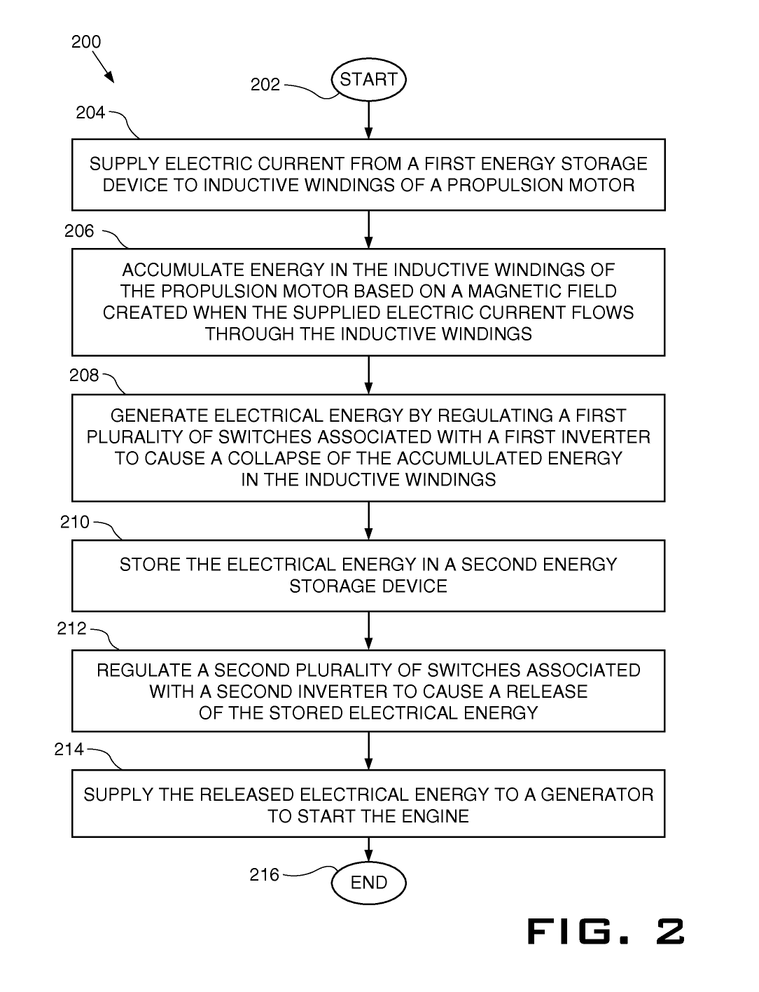

The disclosed system for starting an engine may be provided in any machine or engine where boosting power is a requirement to effectively start the machine or engine. The operation of the will now be explained in connection with the flowchart of FIG. 2.

The flow chart 200 of FIG. 2 shows one exemplary method of starting an engine of an electric drive machine. This can be accomplished by boosting an electrical potential from the first energy storage device 102 to provide a voltage to the generator 114 that is higher than the first energy storage device voltage in order to start the engine 116. This method allows the engine 116 to be started without requiring the use of a separate starter or a separate power booster. The flow chart 200 shows exemplary operations for performing the method to start the engine 116.

The method starts in operation 202. In operation 204, current is supplied from the first energy storage device 102 to inductive windings L₁, L₂ and L₃ of a propulsion motor 104. The controller 106 can be configured to close the first and second first energy storage device switches 103, 105, thereby connecting the first energy storage device 102 to the first inverter 108. In operation 206, energy is accumulated in the inductive windings L₁, L₂ and L₃ of the propulsion motor 104 based on a magnetic field created when the supplied electric current flows through the inductive windings L₁, L₂ and L₃. To facilitate such energy accumulation in the inductive windings L₁, L₂ and L₃ of the propulsion motor 104, the controller 106 may close, for example, switches 130, 131,132 to complete a circuit through the first inverter 108 and the propulsion motor 104 and to start current flowing. By closing the switching elements 130, 131,132 for example, current flows from the first energy storage device 102 directly to the inductive windings L₁, L₂ and L₃ of the propulsion motor 104. The current continues to flow through the inductive windings L₁, L₂ and L₃ and through the switching elements 130, 131 and 132 and through the second first energy storage device switch 105. In the circuit 100, energy is then stored in the inductive windings L₁, L₂ and L₃ of the propulsion motor 104. Other combinations of components may be used to store energy in the inductive windings L₁, L₂ and L₃. For example, the inductive winding L₁ may be connected between switching elements 121 and 131. In this case, switching elements 130 and 132 would be activated to complete the circuit. Other combinations are contemplated and included within the scope of this disclosure.

In operation 208, electrical energy is generated by regulating the first plurality of switches associated with the first inverter 108 to cause a collapse of the accumulated energy in the inductive windings L₁, L₂ and L₃. Thus, after a period of time, or alternatively, when the inductive windings L₁, L₂ and L₃ in the propulsion motor 104 contain a sufficient amount of energy as determined by the controller 106, the controller 106 may regulate the first plurality of switches associated with the first inverter 108 by, for example, opening the switching elements 130, 131 and 132 to cause the collapse of the accumulated energy in the inductive windings L₁, L₂ and L₃, in operation 208. In operation 210, the electrical energy generated from the collapse of the accumulated energy in the inductive windings L₁, L₂ and L₃ is stored in the second energy storage device 112. This may be achieved by the controller 106 causing the energy stored in the inductive windings L₁, L₂ and L₃ to forward bias the diodes 140, 141 and 142 associated with the switching elements 120, 121 and 122 respectively, thereby allowing the energy from the inductive windings L₁, L₂ and L₃ to be released through the diodes 140, 141 and 142 to the second energy storage device 112. The controller 106 may repeat the regulating of the switching elements by, for example, closing and opening of the switching elements 130, 131 and 132 so as to send additional energy to the second energy storage device 112, as described with reference to operation 208. By repeating the operation of regulating the switching elements 130, 131 and 132, energy from the inductive windings L₁, L₂ and L₃ may accumulate within the second storage energy device 112. Accordingly, the closing and opening of the switching elements 130, 131 and 132 may be repeated until the voltage level in the second energy storage device 112 is sufficient to start the engine 116. In one exemplary embodiment, the controller 106 may monitor the voltage level in the second energy storage device 112 to determine when it is sufficient to start the engine 116. In another exemplary embodiment, the controller 106 may be configured to regulate the switching elements 130, 131 and 132 for a set number of times to increase the voltage level.

In operation 212, the controller 106 may regulate the second plurality of switches associated with second inverter 110 to cause a release of the electrical energy stored in the second energy storage device 112. This can be achieved when adequate voltage is stored in the second energy storage device 112. The controller 106 can then cause the switching elements 160-162 and 170-172 associated with the second inverter 110 to be regulated by opening and/or closing such switching elements to thereby cause a release or discharge of the electrical energy stored in the second energy storage device 112. Such released electrical energy is supplied to the generator 114 to start the engine 116, in operation 214. The process ends in operation 216.

Accordingly, the engine 116 may be started using the electrical energy that has been stored in the inductive windings L₁, L₂ and L₃ and held within the second energy storage device 112. Once the engine 116 is running, switches 103, 105 of the first energy storage device may be opened to disconnect the first energy storage device 102 from the second inverter 110. At this point, the propulsion motor 104 and the generator 114 may be reconfigured for normal machine operation and energy from the engine 116 may be used to drive the propulsion motor 104.

Performing the method disclosed herein boosts the voltage provided by the first energy storage device 102 without requiring additional components, such as a separate starter or a separate power booster to start the engine 116. Because the propulsion motor 104 performs the dual function of driving the electric drive machine 100 and boosting the first energy storage device power level to provide energy to start the engine 116, manufacturing costs may be reduced, and maintenance costs for a starter or separate booster are eliminated.

While this disclosure includes particular examples, it is to be understood that the disclosure is not so limited. Numerous modifications, changes, variations, substitutions and equivalents will occur to those skilled in the art without departing from the spirit and scope of the present disclosure upon a study of the drawings, the specification and the following claims

What is claimed is:

1. A system for starting an engine, comprising:
a first energy storage device to supply electric current;
a propulsion motor having a plurality of inductive windings electrically coupled to the first energy storage device;
a controller configured to:
regulate a first plurality of switches associated with a first inverter to cause a collapse of accumulated energy in the inductive windings and discharge the inductive windings of electrical energy;
store the electrical energy in a second energy storage device, and
regulate a second plurality of switches associated with a second inverter to cause a release of the stored electrical energy; and
a generator, electrically coupled to the second plurality of switches associated with the second inverter, to receive the released electrical energy to start the engine.

2. The system of claim 1, wherein the inductive windings accumulate energy based on a magnetic field created when the supplied electric current flows through the plurality of inductive windings.

3. The system of claim 1, wherein the released electrical energy is at a potential that is, at least in part, required to start the engine.

4. The system of claim 1, wherein the first energy storage device is a battery.

5. The system of claim 1, wherein the second energy storage device is a capacitor.

6. The system of claim 1, wherein the plurality of inductive windings of the propulsion motor are connected to the first energy storage device via a neutral node common to each of the inductive windings.

7. The system of claim 1, wherein the first inverter is regulated by independently switching each of the first plurality of switches through interleaved control operations.

8. The system of claim 1, wherein the second inverter is regulated by independently switching each of the second plurality of switches to produce alternating current.

9. A method for starting an engine of an electric drive machine, comprising:
supplying electric current from a first energy storage device to inductive windings of a propulsion motor;
accumulating energy in the inductive windings of the propulsion motor based on a magnetic field created when the supplied electric current flows through the inductive windings;
generating electrical energy by regulating a first plurality of switches associated with a first inverter to cause a collapse of the accumulated energy in the inductive windings;
storing the electrical energy in a second energy storage device;
regulating a second plurality of switches associated with a second inverter to cause a release of the stored electrical energy; and
supplying the released electrical energy to a generator to start the engine.

10. The method of claim 9, wherein the released electrical energy is at a potential that is, at least in part, required to start the engine.

11. The method of claim 9, wherein the first energy storage source is a battery.

12. The system of claim 9, wherein the second energy storage device is a capacitor.

13. The method of claim 9, wherein the plurality of inductive windings of the propulsion motor are connected to the first energy storage device via a neutral node common to each of the inductive windings.

14. The method of claim 9, wherein the first inverter is regulated by independently switching each of the first plurality of switches through interleaved current control operations.

15. The system of claim 9, wherein the second inverter is regulated by independently switching each of the second plurality of switches to produce alternating current.

16. An electric drive machine, comprising:
an engine;
a first energy storage device to supply electric current;
a propulsion motor having a plurality of inductive windings electrically coupled to the first energy storage device, the inductive windings to accumulate energy based on a magnetic field created when the supplied electric current flows through the plurality of inductive windings;
a controller configured to:
regulate a first plurality of switches associated with a first inverter to cause a collapse of accumulated energy in the inductive windings and discharge the inductive windings of electrical energy,
store the electrical energy in a second energy storage device, and
regulate a second plurality of switches associated with a second inverter to cause a release of the stored electrical energy;
a generator, electrically coupled to the second plurality of switches associated with the second inverter, to receive the released electrical energy, wherein the released electrical energy is at a potential that is, at least in part, required to start the engine; and
a gear train, operatively coupled to the propulsion motor, configured to drive a ground engaging system to move the electric drive machine after the engine is started.

17. The electric drive machine of claim 16, wherein the first energy storage device is a battery.

18. The electric drive machine of claim 16, wherein the second energy storage device is a capacitor.

19. The electric drive machine of claim 16, wherein the plurality of inductive windings of the propulsion motor are connected to the first energy storage device via a neutral node common to each of the inductive windings.

20. The electric drive machine of claim 16, wherein the first inverter is regulated by independently switching each of the first plurality of switches through interleaved control operations.

21. The electric drive machine of claim 16, wherein the second inverter is regulated by independently switching each of the second plurality of switches to produce alternating current.
